(19) United States
(12) Patent Application Publication
(10) Pub. No.: US 2026/0307668 A1
(43) Pub. Date: Oct. 8, 2026

(54) SYSTEMS AND METHODS TO CONTROL OPERATIONS OF ADD-ON VEHICLE SENSORS

(71) Applicant: Ford Global Technologies, LLC, Dearborn, MI (US)

(72) Inventors: Brendan Diamond, Naples, FL (US); Keith Weston, Canton, MI (US); Andrew Brown, Royal Oak, MI (US); Stuart C. Salter, White Lake, MI (US); Mahmoud Yousef Ghannam, Canton, MI (US); Aaron L. Mills, Ann Arbor, MI (US)

(73) Assignee: Ford Global Technologies, LLC, Dearborn, MI (US)

(21) Appl. No.: 19/169,592

(22) Filed: Apr. 3, 2025

(51) Int. Cl. B60W 50/02; B60W 50/00; G07C 5/02; G07C 5/08

(52) U.S. Cl. CPC B60W 50/0225; G07C 5/02; G07C 5/0816; B60W 2050/0083

(57) ABSTRACT

A vehicle including a transceiver, a vehicle control unit (VCU) and a processor is disclosed. The transceiver may receive user inputs and the VCU may determine vehicle operational parameters. The processor may determine that an add-on sensor is connected to the vehicle, and an add-on sensor location on the vehicle. The processor may further determine a preferred manner to control an add-on sensor operation based on the user inputs. The processor may additionally control the add-on sensor operation based on the preferred manner, the vehicle operational parameters and/or the add-on sensor location.

### FIELD

The present disclosure relates to vehicles and more specifically to a system and method to control the operation of an add-on vehicle sensor.

### BACKGROUND

Many users customize their vehicles and/or trailers with aftermarket car accessories or sensors to enhance the vehicle's performance or comfort. For example, many users install add-on cameras, speakers, microphones, ultrasonic sensors, and/or the like to their vehicles to enhance the vehicle's performance. For optimal vehicle operation and desired output, it is important that these add-on sensors operate efficiently in conjunction with the existing vehicle sensors.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts a view of an example vehicle in accordance with the present disclosure.

FIG. 2 depicts a block diagram of a system to control operation of an add-on sensor in accordance with the present disclosure.

FIG. 3 depicts a flow diagram of an example first method to configure an add-on sensor in accordance with the present disclosure.

FIG. 4 depicts a flow diagram of an example second method to control operation of an add-on sensor in accordance with the present disclosure.

### DETAILED DESCRIPTION

### Overview

The present disclosure describes a vehicle that controls operation of an add-on sensor based on user preferences. An add-on sensor may mean any sensor that a vehicle owner/operator may install on the vehicle as an aftermarket accessory. Examples of such add-on sensors include, but are not limited to, cameras, Radio Detection and Ranging (radar) sensors, Light Detection and Ranging (lidar) sensors, microphones, ultrasonic sensors, speakers, and/or the like.

To optimally control the add-on sensor operation, the vehicle may first determine/confirm that the user has connected the add-on sensor to the vehicle based on user inputs. The vehicle may further determine the add-on sensor location on the vehicle, via, e.g., wireless signal triangulation method, the user inputs, inputs obtained from existing pre-installed vehicle sensors (e.g., exterior and interior cameras), and/or the like. The vehicle may additionally determine a “preferred manner” in which the user may desire the add-on sensor to operate based on the user inputs. The vehicle may determine the preferred manner to control the operation of the add-on sensor based on inputs or selection provided by the user to the vehicle. In an exemplary aspect, the preferred manner may either be an “inherited control” or an “independent control”. In this case, the user may provide a selection of whether the user desires the add-on sensor to operate in the inherited control or the independent control on the vehicle's Human-Machine Interface (HMI) or a user device, and the vehicle may obtain such selection from the HMI or the user device. The vehicle may use this selection to determine the preferred manner in which the user desires the vehicle to control the operation of the add-on sensor.

Responsive to determining the preferred manner to operate the add-on sensor, the vehicle may control the add-on sensor operation based on the preferred manner, the determined add-on sensor location and/or one or more vehicle operational parameters. The vehicle operational parameters may be, for example, the vehicle speed, the vehicle movement direction, presence (or absence) of a trailer attached to the vehicle, a current vehicle location, presence and weight of external payload on the vehicle, the operating states of one or more vehicle components (e.g., power takeoff (PTO), strobe lights, backup alarms, vehicle radio or infotainment system, etc.), and/or the like.

In an exemplary aspect, when the preferred manner is inherited control, the vehicle may control the add-on sensor operation based on the operations of one or more existing and similar vehicle sensors. In this case, responsive to determining that the preferred manner for add-on sensor operation is inherited control, the vehicle may first determine a vehicle zone in which the add-on sensor may be present based on the determined add-on sensor location (e.g., by using a 3D geometry of the vehicle that may be pre-stored in a vehicle memory). Thereafter, the vehicle determines one or more existing and similar vehicle sensors that may be located at the vehicle zone (e.g., by using information associated with locations and types of existing vehicle sensors that may be pre-stored in the vehicle memory). The vehicle may then control the add-on sensor operation in the same manner as the operations of these existing, similar vehicle sensors.

On the other hand, when the preferred manner is independent control, the vehicle may control the add-on sensor operation based on the user inputs and the vehicle operational parameters. As an example, in this case, if the user inputs indicate that the user prefers the add-on sensor to operate when the vehicle speed is above 20 miles per hour, the vehicle may activate the add-on sensor when the vehicle speed crosses 20 miles per hour and may deactivate the add-on sensor when the vehicle speed drops below 20 miles per hour. In a similar manner, the vehicle may activate the add-on sensor at specific times of the day, at specific geolocations, during predefined events, and/or the like based on the user inputs.

In some aspects, in addition to controlling the add-on sensor's activation and deactivation, the vehicle may control how long to record/operate the add-on sensor, when and how frequently the data captured by the add-on sensor should be sent to a cloud repository / server for data management, how long the data should be saved for/overwritten, and/or the like.

The vehicle may additionally facilitate the user in optimally connecting the add-on sensor to the vehicle during the sensor's installation process. Specifically, the vehicle may output one or more error notifications when the vehicle determines that the add-on sensor is not correctly capturing data, the add-on sensor is not configurable in relation to the existing vehicle sensors or the add-on sensor may not operate optimally together with the existing vehicle sensors, the add-on sensor is not properly connected, and/or the like. As an example, in this case, the vehicle compares/matches the inputs obtained from the add-on sensor and the readings obtained from existing, similar vehicle sensors, and outputs an error notification indicating an improper sensor connection when the inputs and the readings do not substantially match. The user may take remedial actions responsive to hearing/viewing such an error notification.

The present disclosure discloses a vehicle that ensures optimal operation of an add-on sensor based on user preferences. The vehicle further alerts the user when the add-on sensor is not properly connected to the vehicle or is not functionally correctly, thereby enabling the user to perform timely remedial actions. The vehicle enhances the overall sensor output quality by providing feedback regarding sensor performance, without requiring the engineers or specialized personnel to inspect the vehicle/add-on sensor. The vehicle further provides a means for early detection of aftermarket parts that inhibit sensor performance.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

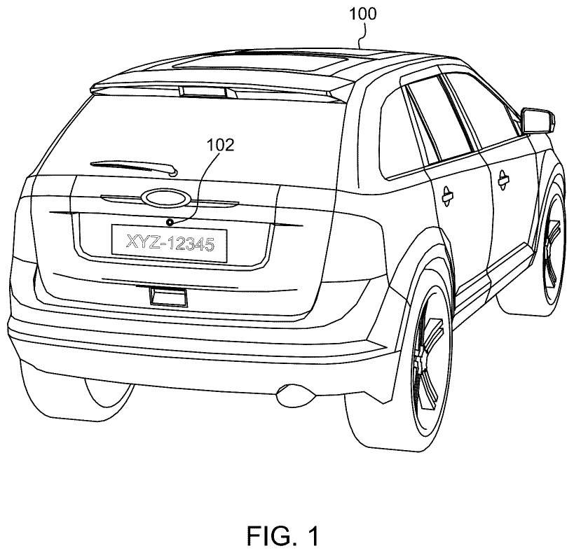

FIG. 1 depicts a view of an example vehicle 100 in accordance with the present disclosure. The vehicle 100 may take the form of any passenger or commercial vehicle such as a car, a work vehicle, a crossover vehicle, a truck, a van, a minivan, a taxi, a bus, etc. The vehicle 100 may be a manually driven vehicle or may be configured to operate in a partially/fully autonomous mode. Further, the vehicle 100 may include any powertrain, such as a gasoline engine, one or more electrically-actuated motor(s), or a hybrid system.

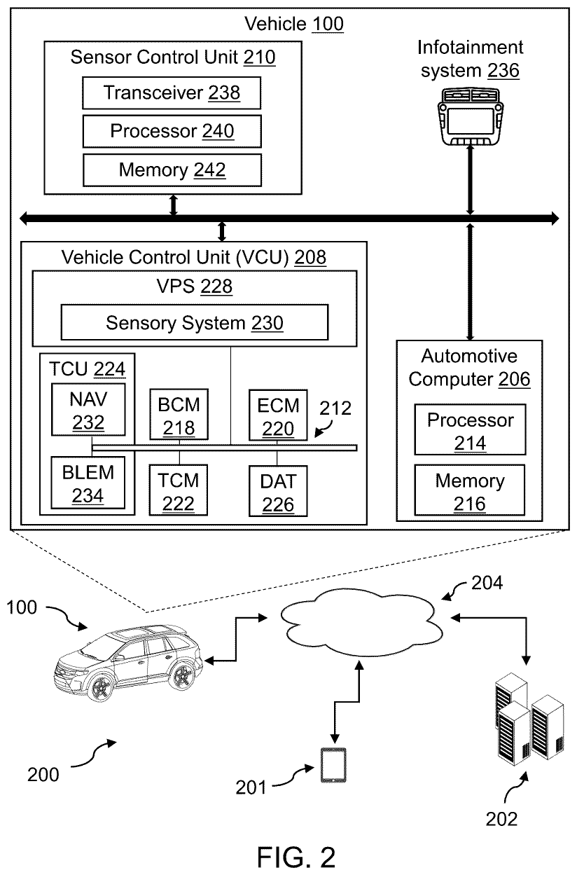

The vehicle 100 may include a plurality of existing or pre-installed vehicle sensors or a sensor suite (shown as vehicle sensory system 230 in FIG. 2) and one or more add-on sensors 102. The term “add-on sensor”, as used in the present disclosure, may mean any sensor that a vehicle owner/operator may have installed on the vehicle 100 as an aftermarket accessory. Stated another way, the add-on sensor 102 may not be incorporated in the vehicle 100 by the vehicle manufacturer during the manufacturing process but may be added to the vehicle 100 by the vehicle operator during or after the vehicle purchase. Furthermore, the term “vehicle”, as used in the present disclosure, means to include a trailer (not shown) as well if the vehicle is attached to the trailer. Consequently, when the present disclosure states that the add-on sensor 102 is connected to the vehicle 100, it may also be construed to mean that the add-on sensor 102 is connected to the trailer if the trailer is attached to the vehicle 100.

The add-on sensor 102 may be, for example, a camera, a Radio Detection and Ranging (radar) sensor, a Light Detection and Ranging (lidar) sensor, a microphone, an ultrasonic sensor, a speaker, and/or the like. The exemplary aspect depicted in FIG. 1 and the description below illustrates/describes an aspect where the add-on sensor 102 is a rear view camera; however, such depiction and description should not be construed as limiting. The add-on sensor 102 may be any type of sensor or accessory that the vehicle operator may connect to any location of the vehicle 100 to enhance the vehicle's performance and user comfort, without departing from the scope of the present disclosure.

It may be appreciated that for optimal vehicle performance and desired output, it is important that the add-on sensor 102 operates efficiently in conjunction with the vehicle sensors and in accordance with the user requirements/preferences. To enable the add-on sensor 102 to operate in an efficient manner, the vehicle 100 may include a sensor control unit (shown as sensor control unit 210 in FIG. 2) that controls the operation of the add-on sensor 102 based on vehicle operator/user preferences. Functioning of the vehicle's sensor control unit (“unit”) is briefly described below and described in detail later in conjunction with FIG. 2.

In an exemplary aspect, as a first step, the unit may determine the presence of the add-on sensor 102 on the vehicle 100 when the user connects/attaches the add-on sensor 102 on the vehicle 100. The user may connect the add-on sensor 102 to the vehicle 100 via one or more brackets, magnetic attachments, adhesives, etc. In some aspects, the unit may determine the add-on sensor presence on the vehicle 100 via user inputs, which the user may provide to the vehicle 100 via a user device and/or a vehicle Human-Machine Interface (HMI) while connecting/installing the add-on sensor 102 on the vehicle 100. In an exemplary aspect, the user inputs may be indicative of how the user desires the add-on sensor 102 to operate (or a “preferred manner” in which the add-on sensor 102 should operate), when to activate and deactivate the add-on sensor 102, a time duration to operate the add-on sensor 102, what data should the add-on sensor 102 record or capture, how and where to output the add-on sensor readings/data, and/or the like.

Responsive to determining the add-on sensor presence on the vehicle 100, the unit may determine and/or estimate the location of the add-on sensor 102 on the vehicle 100. The unit may implement one or more different methods to determine the add-on sensor location on the vehicle 100. For example, the unit may determine the add-on sensor location via wireless signal triangulation from the add-on sensor 102 to the vehicle 100. In some aspects, the add-on sensor 102 may be connected with the vehicle 100 via wired or wireless communication. The unit may use the signals obtained from the add-on sensor 102 to estimate add-on sensor location via wireless signal triangulation method. As another example, the unit may determine the add-on sensor location via inputs obtained from the existing vehicle sensory system or sensor suite. For example, the unit may determine the add-on sensor location based on images obtained from vehicle's existing cameras (e.g., images of the installed add-on sensor 102 or images captured when the user may be installing the add-on sensor 102 on the vehicle 100). As yet another example, the unit may determine the add-on sensor location via user inputs that the user may provide to the vehicle 100 while installing/connecting the add-on sensor 102.

The unit may further control the add-on sensor operation based on the preferred manner in which the user desires the add-on sensor 102 to operate (that may be part of the user inputs, as described above), the determined add-on sensor location and/or one or more vehicle operational parameters. The vehicle operational parameters may be, for example, a vehicle speed, a vehicle movement direction, a presence (or absence) of a trailer attached to the vehicle 100, a current vehicle location, a presence and weight of external payload on the vehicle 100, operating states of one or more vehicle components (e.g., power takeoff (PTO), strobe lights, backup alarms, vehicle radio or infotainment system, etc.), and/or the like.

In some aspects, the preferred manner of add-on sensor operation, as described above, may be one of an “inherited control” or an “independent control”. In some aspects, the unit may determine the preferred manner to control an operation of the add-on sensor 102 based on the user input that the user may provide to the vehicle 100 while installing the add-on sensor 102 to the vehicle 100 or before/after installing the add-on sensor 102. For example, while installing the add-on sensor 102, the user may provide inputs on the vehicle's HMI or the user device indicating that the user desires the add-on sensor 102 to operate in the “inherited control” manner or the “independent control” manner. The unit may obtain such inputs from the HMI or the user device and determine the preferred manner to control the operation of the add-on sensor 102 based on the obtained user input.

When the user indicates in the user inputs that the user prefers the add-on sensor 102 to have inherited control, the unit may control the add-on sensor operation based on the operations of one or more existing vehicle sensors. In this case, responsive to determining that the preferred manner to control the add-on sensor operation is inherited control, the unit may first determine a vehicle zone in which the add-on sensor 102 may be present based on the determined add-on sensor location (e.g., by using a 3D geometry of the vehicle 100 that may be pre-stored in a vehicle memory). For example, the unit may determine that the add-on sensor 102 is located at a rear exterior vehicle zone when the add-on sensor location indicates that the add-on sensor 102 is connected to a vehicle rear portion (as shown in FIG. 1). Similarly, the unit may determine that the add-on sensor 102 may be located at a front vehicle zone, a right vehicle zone, a left vehicle zone, an interior vehicle zone, an exterior vehicle zone, and/or the like, based on the add-on sensor location. Responsive to determining the vehicle zone in which the add-on sensor 102 may be present, the unit may determine one or more existing and similar vehicle sensors that may be located at the vehicle zone (e.g., by using information associated with locations and types of existing vehicle sensors that may be pre-stored in the vehicle memory). For example, if the determined vehicle zone is the rear exterior vehicle zone and the add-on sensor 102 is a camera, the unit may determine one or more existing rear cameras that may be located at the rear exterior vehicle zone. Thereafter, the unit may control the add-on sensor operation in the same manner as the operations of these existing vehicle sensors.

For example, in the aspect described above, the unit may control the add-on camera operation in the same manner as the operations of the existing rear vehicle cameras. In this case, the unit may activate the add-on rear camera at the same time the existing rear vehicle cameras are activated, deactivate the add-on rear camera at the same time the existing rear vehicle cameras are deactivated, align the add-on rear camera's field of view (FOV) in the same manner as the existing rear vehicle cameras'FOV, output, record and/or transmit the images captured by the add-on rear camera in the similar manner as the existing rear vehicle cameras perform these functions, and/or the like. As another example, if the existing rear vehicle cameras are programmed to get activated and capture images when one of a predefined events takes place (when another vehicle gets too close to the vehicle 100 or contacts the vehicle 100), the unit may program and control the add-on rear camera operation in a similar manner.

On the other hand, when the user indicates in the user inputs that the user prefers the add-on sensor 102 to have independent control (or the preferred manner to control the operation of the add-on sensor 102 is the independent control manner), the unit may control the add-on sensor operation based on the user inputs and the vehicle operational parameters. As an example, in this case, if the user inputs indicate that the user prefers the add-on sensor 102 to operate when the vehicle speed is above 20 miles per hour, the unit may activate the add-on sensor 102 when the vehicle speed crosses 20 miles per hour and may deactivate the add-on sensor 102 when the vehicle speed drops below 20 miles per hour. In this case, the unit obtains the real-time vehicle's operational parameters from a vehicle control unit (shown as VCU 208 in FIG. 2) and control the add-on sensor operation based on the obtained inputs. Additional examples of user inputs or preferences for the add-on sensor activation may include, but are not limited to, activate the add-on sensor 102 when the vehicle 100 is connected to a trailer and the vehicle 100 is reversing, operate/activate the add-on sensor 102 only when the vehicle 100 is in a specific geolocation (e.g., user's home or office), operate/activate the add-on sensor 102 only at specific times (e.g., during nighttime), operate/activate the add-on sensor 102 when the vehicle 100 is loaded (e.g., payload above a calibrated threshold), operate/activate the add-on sensor 102 when one or more vehicle components are activated (e.g., PTO, strobe lights, backup alarm, radio, etc.), operate/activate the add-on sensor 102 only when the vehicle 100 is traveling in a particular direction (e.g., forward or reverse), and/or the like.

As another example of user inputs or preferences for the add-on sensor activation, the unit may activate/operate the add-on sensor 102 only when the unit determines that the user is performing a predetermined user-defined action or a predefined action (e.g., gardening, house painting, recreational activity, etc.) in proximity to the vehicle 100 (which the unit determines based on inputs obtained from the vehicle's sensory system). In this case, in an exemplary aspect, the vehicle 100 may pre-store a plurality of images (or “stock images”) of users performing various predefined actions, e.g., gardening, house painting, recreational activity, etc. The vehicle 100 may further obtain a real-time image of the user performing an activity in proximity to the vehicle 100, by using the vehicle's exterior camera. The vehicle 100 may then compare the real-time image with the stock images to determine if the user may be performing one of the user-defined action or predefined action. When the real-time image and one of the stock images substantially match, the vehicle 100 may determine that the user may be performing the user-defined action or predefined action. Responsive to such determination, the vehicle 100 may control the operation of the add-on sensor 102 based on the predefined action or the user defined action. For example, in this case, responsive to determining that the user is performing the predefined action or the user defined action, the vehicle 100 may activate the add-on sensor 102.

As another example, the user may provide audible inputs to the vehicle 100 indicating the type of activity/action that the user may be performing in proximity to the vehicle 100, which the vehicle's microphone (which may be part of the vehicle's sensory system) may capture. In this case, the vehicle 100 may determine the type of action that the user may be performing based on the user's audible inputs, and determine whether the action is the same as the user defined or predefined action. Responsive to determining that the action is the same as the user defined or predefined action, the vehicle 100 may accordingly control the operation of the add-on sensor 102 (e.g., activate the add-on sensor 102).

In this manner, the unit activates/controls the add-on sensor operation based on the user inputs/preferred manner of add-on sensor operation, the add-on sensor location and/or the real-time vehicle operational parameters. In some aspects, in addition to controlling the add-on sensor's activation and deactivation, the unit may control (based on the user inputs) how long to record/operate the add-on sensor 102, when and how frequently data captured by the add-on sensor 102 should be sent to a cloud repository/server for data management, how long the data should be saved for/overwritten, what should the add-on sensor 102 record (utilize image recognition, etc.), where should the add-on sensor 102 focus, how the add-on sensor's output should be communicated (visual, audio, etc.) to the user (e.g., should it take the place of the display of another sensor on the HMI, where should the display be located on the HMI, when should audio be communicated and what message should be relayed, etc.), and/or the like. In this manner, the unit controls the entire operation of the add-on sensor 102 based on user preferences, thereby considerably enhancing user convenience.

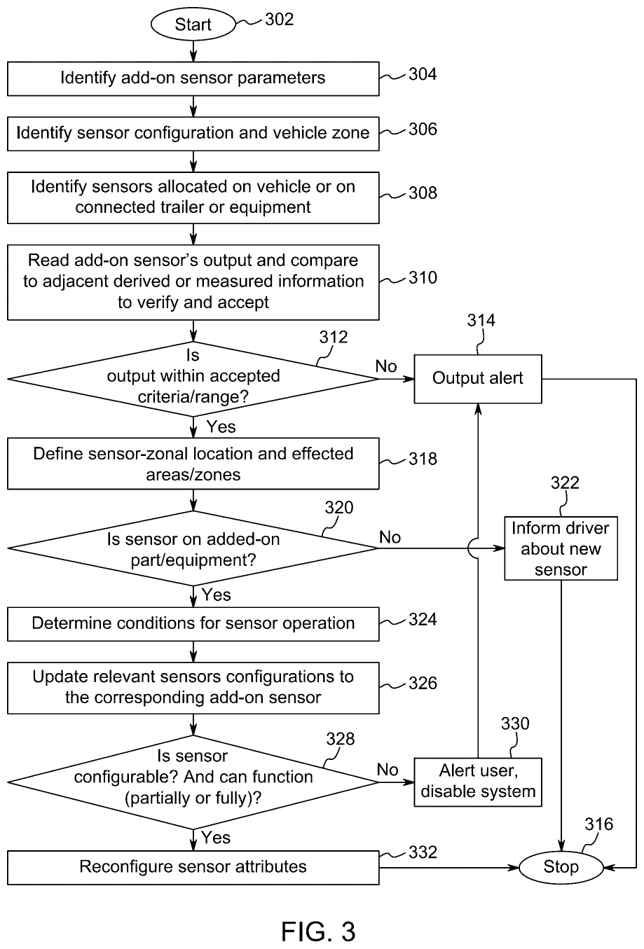

The unit may further facilitate the user in optimally connecting the add-on sensor 102 during the sensor installation process. Specifically, the unit may output one or more error notifications on the user device and/or the vehicle HMI when the unit determines that the add-on sensor 102 is not correctly capturing data, the add-on sensor 102 is not configurable in relation to the existing vehicle sensors or the add-on sensor 102 may not operate optimally together with the existing vehicle sensors, the add-on sensor 102 is not properly connected, and/or the like. The user may perform remedial actions responsive to viewing/hearing these error notifications, thereby enabling the user to efficiently connect the add-on sensor 102 to the vehicle 100. A detailed process of facilitating the user in optimally connecting the add-on sensor 102 and further vehicle 100 details are described below in conjunction with FIGS. 2 and 3.

The vehicle 100 implements and/or performs operations, as described here in the present disclosure, in accordance with the owner manual and safety guidelines. In addition, any action taken by the user based on the notifications provided by the vehicle 100 should comply with all the rules specific to the location and operation of the vehicle 100 (e.g., Federal, state, country, city, etc.). The notifications, as provided by the vehicle 100 should be treated as suggestions and only followed according to any rules specific to the location and operation of the vehicle 100.

FIG. 2 depicts a block diagram of a system 200 to control the add-on sensor operation in accordance with the present disclosure. While describing FIG. 2, references will be made to FIG. 3.

The system 200 may include the vehicle 100, a user device 201 and one or more servers 202 (or a server 202) that may be communicatively coupled with each other via one or more networks 204. The user device 201 may be associated with the vehicle operator/user and may be, for example, a mobile phone, a laptop, a computer, a tablet, a smartwatch, or any other similar device with communication capabilities. The server 202 may be part of a cloud-based computing infrastructure and may be associated with and/or include a Telematics Service Delivery Network (SDN) that provides digital data services to the vehicle 100 and other vehicles (not shown in FIG. 2) that may be part of a vehicle fleet. In further aspects, the server 202 may store, process and/or analyze sensor data/readings obtained from sensors installed on a plurality of vehicles (including the vehicle 100).

The network(s) 204 illustrates an example communication infrastructure in which the connected devices discussed in various embodiments of this disclosure may communicate. The network(s) 204 may be and/or include the Internet, a private network, public network or other configuration that operates using any one or more known communication protocols such as transmission control protocol/Internet protocol (TCP/IP), Bluetooth®, Bluetooth Low Energy (BLE), Wi-Fi based on the Institute of Electrical and Electronics Engineers (IEEE) standard 802.11, Ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

The vehicle 100 may include a plurality of units including, but not limited to, an automotive computer 206, a Vehicle Control Unit (VCU) 208 and a sensor control unit 210 (or unit 210). The VCU 208 may include a plurality of Electronic Control Units (ECUs) 212 in communication with the automotive computer 206.

In some aspects, the automotive computer 206 and/or the unit 210 may be installed anywhere in the vehicle 100, in accordance with the disclosure. Further, the automotive computer 206 may operate as a functional part of the unit 210. The automotive computer 206 may be or include an electronic vehicle controller, having one or more processor(s) 214 and a memory 216. Moreover, the unit 210 may be separate from the automotive computer 206 (as shown in FIG. 2) or may be integrated as part of the automotive computer 206.

The processor(s) 214 may be in communication with one or more memory devices in communication with the respective computing systems (e.g., the memory 216 and/or one or more external databases not shown in FIG. 2). The processor(s) 214 may utilize the memory 216 to store programs in code and/or to store data for performing aspects in accordance with the disclosure. The memory 216 may be a non-transitory computer-readable medium or memory storing a sensor control program code. The memory 216 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

In accordance with some aspects, the VCU 208 may share a power bus with the automotive computer 206 and may be configured and/or programmed to coordinate the data between vehicle 100 systems, connected servers (e.g., the server(s) 202), the user device 201 and other vehicles (not shown in FIG. 2) operating as part of a vehicle fleet. The VCU 208 may further determine one or more vehicle operational parameters in real-time. The examples of the vehicle operational parameters are already described above in conjunction with FIG. 1.

The VCU 208 may include or communicate with any combination of the ECUs 212, such as a Body Control Module (BCM) 218, an Engine Control Module (ECM) 220, a Transmission Control Module (TCM) 222, a Telematics Control Unit (TCU) 224, a Driver Assistances Technologies (DAT) controller 226, etc.

The VCU 208 may further include and/or communicate with a Vehicle Perception System (VPS) 228, having connectivity with and/or control of one or more vehicle sensory system(s) 230 (or a “sensor unit”). The vehicle sensory system 230 may include one or more vehicle sensors (e.g., pre-installed sensors) including, but not limited to, a radio detection and ranging (radar) sensor configured for detection and localization of objects inside and outside the vehicle 100 using radio waves, sitting area buckle sensors, sitting area sensors, a light detecting and ranging (lidar) sensor, door sensors, proximity sensors, temperature sensors, wheel sensors, ambient weather sensors, ambient light sensors, vehicle interior and exterior cameras, one or more rain sensors, a humidity sensor, a tire pressure sensor, ultrasonic sensors, one or more microphones, etc.

In some aspects, the VCU 208 may control vehicle operational aspects and implement one or more instruction sets received from the user device 201, from one or more instruction sets stored in the memory 216, including instructions operational as part of the unit 210.

The TCU 224 may provide vehicle connectivity to wireless computing systems onboard and off board the vehicle 100 and may include a Navigation (NAV) receiver 232 for receiving and processing a GPS signal, a BLE Module (BLEM) 234, a Wi-Fi transceiver, a UWB transceiver, and/or other wireless transceivers (not shown in FIG. 2) that may be configurable for wireless communication (including cellular communication) between the vehicle 100 and other systems (e.g., the user device 201, a key fob, an NFC device, etc.), computers, and modules. The NAV receiver 232 may be configured to determine a real-time vehicle geolocation. The TCU 224 may be in communication with the ECUs 212 by way of a bus.

The ECUs 212 may control aspects of vehicle operation and communication using inputs from human drivers, inputs from an autonomous vehicle controller, the unit 210, and/or via wireless signal inputs received via the wireless connection(s) from other connected devices, such as the user device 201, the server(s) 202, among others.

The BCM 218 generally includes integration of sensors, vehicle performance indicators, and variable reactors associated with vehicle systems and may include processor-based power distribution circuitry that can control functions associated with the vehicle body such as lights, windows, security, camera(s), fan, headlights, audio system(s), speakers, wipers, door locks and access control, mirrors, various comfort controls, and/or the like. The BCM 218 may also operate as a gateway for bus and network interfaces to interact with remote ECUs (not shown in FIG. 2).

The DAT controller 226 may provide Level-1 through Level-3 automated driving and driver assistance functionality that may include, for example, active parking assistance, vehicle backup assistance, and adaptive cruise control, among other features. The DAT controller 226 may also provide aspects of user and environmental inputs usable for user authentication.

In some aspects, the automotive computer 206 may connect with an infotainment system 236 (or a vehicle Human-Machine Interface (HMI) 236). The infotainment system 236 may include a touchscreen interface portion and may include voice recognition features, biometric identification capabilities that can identify users based on facial recognition, voice recognition, fingerprint identification, or other biological identification means. In other aspects, the infotainment system 236 may further receive user instructions/inputs via the touchscreen interface portion and/or display notifications/recommendations, navigation maps, etc. on the touchscreen interface portion.

The computing system architecture of the automotive computer 206, the VCU 208, and/or the unit 210 may omit certain computing modules. It should be readily understood that the computing environment depicted in FIG. 2 is an example of a possible implementation according to the present disclosure, and thus, it should not be considered limiting or exclusive.

In accordance with some aspects, the unit 210 may be integrated with and/or executed as part of the ECUs 212. The unit 210, regardless of whether it is integrated with the automotive computer 206 or the ECUs 212, or whether it operates as an independent computing system in the vehicle 100, may include a transceiver 238, a processor 240, and a computer-readable memory 242.

The transceiver 238 may receive information/inputs from one or more external devices or systems, e.g., the user device 201, the server(s) 202, and/or the like via the network 204. For example, the transceiver 238 may receive the user inputs described above in conjunction with FIG. 1 from the user via the user device 201. Further, the transceiver 238 may transmit notifications/data/signals to the external devices or systems. In addition, the transceiver 238 may receive information/inputs from vehicle 100 components such as the infotainment system 236, the VCU 208, and/or the like. Further, the transceiver 238 may transmit notifications/command signals to the vehicle 100 components such as the VCU 208, the infotainment system 236, the BCM 218, etc.

The processor 240 and the memory 242 may be the same as or similar to the processor 214 and the memory 216, respectively. In some aspects, the processor 240 may utilize the memory 242 to store programs in code and/or to store data for performing aspects in accordance with the disclosure. The memory 242 may be a non-transitory computer-readable medium or memory storing the sensor control program code.

In operation, the transceiver 238 may receive, via the user device 201 or the infotainment system 236, the user inputs indicative of the preferred manner in which the user desires the vehicle 100 to control the operation of the add-on sensor 102. The user may provide the user inputs when the user may be installing/connecting the add-on sensor 102 to the vehicle 100, or before or after the installation process. In some aspects, the add-on sensor 102 may draw power from the vehicle's battery, solar power, or its own in-built battery when the add-on sensor 102 may be installed/connected to the vehicle 100. Furthermore, the add-on sensor 102 may get communicatively coupled, via wired or wireless connection, with the vehicle 100/processor 240, when the add-on sensor 102 may be installed/connected to the vehicle 100.

After receiving the user inputs from the user, the transceiver 238 may transmit the user inputs to the processor 240. Responsive to obtaining the user inputs, the processor 240 may determine/confirm that the add-on sensor 102 is connected to the vehicle 100. The processor 240 may then determine the add-on sensor location on the vehicle 100. As described above, the processor 240 may determine/estimate the add-on sensor location via wireless signal triangulation method, the user inputs (when the user specifies where the user has connected the add-on sensor 102 on the vehicle 100), or inputs obtained from the sensors included in the vehicle sensory system 230 (e.g., images obtained from the existing vehicle cameras).

The processor 240 may further determine the user's preferred manner to control the operation of the add-on sensor 102 based on the obtained user inputs (that the user may provide to the vehicle 100 before, during or after installing the add-on sensor 102 to the vehicle 100), as described above. As described above in conjunction with FIG. 1, the preferred manner to control the operation of the add-on sensor 102 may be inherited control or independent control of add-on sensor operation. The processor 240 may then control the add-on sensor operation based on the preferred manner, the user inputs, the add-on sensor location and/or the real-time vehicle operational parameters, as described below.

In an exemplary aspect, when the user's preferred manner to control the operation of the add-on sensor 102 is independent control (as determined based on the user inputs/selection obtained from the user), the processor 240 may control the add-on sensor operation based on the real-time vehicle operational parameters and the user inputs. In this case, the processor 240 may control the add-on sensor operation independently and separate from the operation of the other existing vehicle sensors. For example, if the user preferred manner is independent control and the user inputs indicate that the user desires the add-on sensor 102 to be activated whenever the vehicle speed exceeds 20 miles per hour, the processor 240 may activate the add-on sensor 102 whenever the vehicle speed exceeds 20 miles per hour (as determined from the inputs obtained from the VCU 208). The processor 240 may further record the readings/data obtained from the add-on sensor 102, post its activation, and transmit the readings to the user device 201, the infotainment system 236, and/or the server 202 based on the user preferences of handling the recorded data (as indicated in the user inputs).

As another example, if the user inputs indicate that the user desires the add-on sensor 102 to be activated whenever the vehicle 100 is reversing and attached to a trailer, the processor 240 may activate the add-on sensor 102 whenever such a vehicle condition is satisfied. As yet another example, if the user inputs indicate that the user desires the add-on sensor 102 to be activated whenever the vehicle 100 is located is a specified geofenced location (e.g., the user's home), the processor 240 may correlate the real-time vehicle location (determined based on inputs obtained from the TCU 224) with the specified geofenced location and activate the add-on sensor 102 whenever the real-time vehicle location matches with the specified geofenced location.

As yet another example, if the user inputs indicate that the user desires the add-on sensor 102 to be activated when the vehicle 100 is loaded (e.g., payload is above a calibrated threshold) or whenever one or more other vehicle components are activated (e.g., PTO, radio, strobe lights, backup alarm, etc.), the processor 240 may activate the add-on sensor 102 whenever such vehicle conditions are satisfied. For example, if the add-on sensor 102 is a speaker and the user inputs indicate that the user desires the add-on speaker to be activated whenever the user turns ON the vehicle radio, the processor 240 may activate the add-on speaker whenever the user turns ON the vehicle radio.

As another example, if the user inputs indicate that the user desires the add-on sensor 102 to be activated based on a specific direction of vehicle movement (e.g., forward or backward) relative to the add-on sensor 102, the processor 240 may activate the add-on sensor 102 whenever the vehicle 100 is moving in the specified direction (determined based on the inputs obtained from the VCU 208). As another example, if the user inputs indicate that the user desires the add-on sensor 102 to be activated whenever the user is performing a predetermined user-defined action (e.g., gardening, lawn mowing, deck building/repair, house painting, recreational activities, exercising, RV riding, etc.) in proximity to the vehicle 100, the processor 240 may activate the add-on sensor 102 whenever the user may be performing such actions in proximity to the vehicle 100. In this case, the processor 240 may first determine that the user may be performing the predefined action in proximity to the vehicle 100 based on the inputs obtained from the vehicle sensory system 230 and then activate/control the add-on sensor operation responsive to identifying and/or based on the predefined action.

In this case, as described above in conjunction with FIG. 1, in one exemplary aspect, the processor 240 may obtain the real-time images of the user performing an activity/action in proximity to the vehicle 100 via the vehicle's exterior cameras (which may be part of the vehicle sensory system 230). The processor 240 may then compare the real-time images with the plurality of stock images that may be pre-stored in the memory 242. The processor 240 may determine that the user may be performing a predefined action or activity when the real-time images substantially match with at least one stock image. The processor 240 may further activate the add-on sensor 102 (or control its operation) responsive to identifying and/or based on the predefined action that the user is performing. For example, if the user inputs indicate that the add-on sensor 102 should be switched ON for 5 minutes whenever the user is performing gardening in proximity to the vehicle 100, the processor 240 may activate the add-on sensor 102 for 5 minutes when the processor 240 determines that the user is performing gardening (determined based on the user's images captured by the vehicle's exterior cameras).

As another example, as described above in conjunction with FIG. 1, the user may indicate the type of action being performed by the user in proximity to the vehicle 100 via an audible message, which the vehicle's microphone may capture. In this case, the processor 240 may determine whether the user is performing the predefined action/activity based on the audible message, and may accordingly control the operation of the add-on sensor 102 as described above.

The examples of independent control of the add-on sensor operation described above should not be construed as limiting. The user inputs may indicate additional and/or different types of manners in which the user may desire the add-on sensor 102 to be operated, and the processor 240 may accordingly control the add-on sensor operation without departing from the present disclosure scope. Furthermore, the user inputs may not only indicate when to activate the add-on sensor 102, but may also indicate a time duration for which the add-on sensor 102 should be operated or when to deactivate the add-on sensor 102 and how the readings/data obtained from the add-on sensor 102 should be handled, stored, output, and/or the like. Consequently, the processor 240 may control not just the add-on sensor activation based on the user inputs, but also the deactivating or turning OFF of the add-on sensor 102 after a predefined time duration and transmitting of the data obtained from the add-on sensor 102 to the server 202, the infotainment system 236, the user device 201 and/or the memory 242.

In some aspects, when the user's preferred manner to control the operation of the add-on sensor 102 is inherited control (as determined based on the user inputs/selection obtained from the user), the processor 240 may control the add-on sensor operation based on the add-on sensor location on the vehicle 100 and operations of one or more existing and similar vehicle sensors (that may be part of the vehicle sensory system 230). In this case, as described above in conjunction with FIG. 1, the processor 240 may first determine a vehicle zone in which the add-on sensor 102 may be present based on the determined add-on sensor location (e.g., by using a 3D geometry of the vehicle 100 that may be pre-stored in the memory 242). As an example, in this case, the processor 240 may correlate the determined add-on sensor location with the 3D geometry/map of the vehicle 100 and determine the vehicle zone in which the add-on sensor 102 may be present based on the correlation. The processor 240 may then determine/identify one or more existing and similar vehicle sensors that may be located at the vehicle zone (e.g., by using information associated with locations and types of different existing vehicle sensors that may be pre-stored in the memory 242). For example, if the determined vehicle zone is the rear exterior vehicle zone and the add-on sensor 102 is a camera, the processor 240 may use the stored information described above to determine one or more existing rear cameras that may be located at the rear exterior vehicle zone. The processor 240 may then control the add-on sensor operation in the same manner as the operations of the identified existing, similar vehicle sensors. The examples of controlling the add-on sensor operation based on the operations of the existing vehicle sensors are already described above in conjunction with FIG. 1.

As briefly described above, the processor 240 may further facilitate the user in optimally connecting the add-on sensor 102 to the vehicle 100 during the installation process. Specifically, the processor 240 may output one or more error notifications when the add-on sensor 102 may not be connected properly or its readings may not match with other similar vehicle sensors, so that the user may rectify the error. An example process implemented by the processor 240 to facilitate the user in optimally connecting the add-on sensor 102 to the vehicle 100 is described below.

In an exemplary aspect, the processor 240 may first obtain inputs from the add-on sensor 102 when the add-on sensor 102 is connected to the vehicle 100 and activated by the processor 240. The processor 240 may further obtain readings from existing and/or similar vehicle sensors (or other known parameters such as temperature, pressure, etc.) and compare the readings with the inputs obtained from the add-on sensor 102. For example, if the user attaches an add-on camera, radar or lidar sensor to the vehicle 100, the processor 240 may perform pattern matching between the readings obtained from existing on-board vehicle sensors and the inputs obtained from the add-on sensor. In an exemplary aspect, the processor 240 may perform this step when the vehicle 100 may be driven in a straight line at nominal speeds, and then the processor 240 may identify distinct patterns (e.g., curbs, poles, etc.) that show up in the readings of both the on-board and add-on sensors and calculate their relative positioning.

The processor 240 may output a first error notification on the user device 201 and/or the infotainment system 236 when a difference between the inputs obtained from the add-on sensor 102 and the readings obtained from the existing on-board vehicle sensors is greater than a predefined threshold. It may be appreciated that if the difference is large, it may indicate that the add-on sensor 102 and the existing, similar vehicle sensors are “reading” or focusing on different aspects, areas and/or FOVs, and hence the add-on sensor 102 may not be correctly connected. In this case, the user may perform remedial actions to correctly connect the add-on sensor 102 to the vehicle 100 responsive to hearing/viewing the first error notification.

On the other hand, if the difference is small (e.g., less than the predefined threshold), the processor 240 may not output the first error notification and may instead determine that the add-on sensor 102 may be connected to the vehicle 100 in a potentially correct manner by the user.

The processor 240 may further determine whether the add-on sensor 102 is configurable based on the inputs obtained from the ad-on sensor 102 (e.g., if the inputs are within permissible range, of similar type as existing readings, and/or the like). The processor 240 may output a second error notification on the user device 201 and/or the infotainment system 236 responsive to determining that the add-on sensor 102 is not configurable. In a similar manner as described above, the user may perform remedial actions responsive to hearing/viewing the second error notification. On the other hand, the processor 240 may configure the add-on sensor 102 and the existing, similar vehicle sensors to operate together responsive to determining that the add-on sensor 102 is configurable. An example process 300 (or a “first method”) implemented by the processor 240 to configure the add-on sensor 102 is depicted in FIG. 3 and described below.

The process 300 may start at step 302. At step 304, the processor 240 may identify the add-on sensor parameters such as FOV, voltage, measuring property (temperature, pressure, etc.), when the user connects the add-on sensor 102 to the vehicle 100. At step 306, the processor 240 may identify the add-on sensor configurations and/or the vehicle zone at which the add-on sensor 102 may be connected. At step 308, the processor 240 may identify sensors allocated to or present at the vehicle zone or connected on the trailer/equipment where the add-on sensor 102 may be connected. At step 310, the processor 240 may read add-on sensor's output and compare it with adjacent derived or measured information (e.g., temperature, pressure, etc.) to verify and accept.

At step 312, the processor 240 may determine whether the output from the add-on sensor 102 is within an accepted criteria/range. If the output is not within the accepted range, then at step 314, the processor 240 may output an alert or error notification (e.g., stating that the measurements are not matching). The user may then perform remedial actions after viewing / hearing this alert. After the step 314, the process 300 may move to step 316, at which the process 300 may stop.

On the other hand, if the output is within the accepted range, then at step 318, the processor 240 may define the add-on sensor's zonal location and the affected areas/zones/FOVs. At step 320, the processor 240 may determine whether the add-on sensor 102 is an added-on part/equipment (e.g., an add-on camera to existing cameras). If the add-on sensor 102 is not an added-on part/equipment, then at step 322, the processor 240 may inform (i.e., output a notification for) the user about the new sensor. The process 300 may move to the step 316 after the step 322.

On the other hand, if the add-on sensor 102 is an added-on part/equipment, then at step 324, the processor 240 may determine the conditions for the add-on sensor operation (if defined by the user). At step 326, the processor 240 may update the relevant sensors'configurations to the corresponding add-on sensor 102.

At step 328, the processor 240 may determine whether the add-on sensor 102 is configurable and can still function (partially or fully) after the step 326. If the add-on sensor 102 is not configurable or cannot function, then at step 330, the processor 240 may alert the user (via the alert notification shown in the step 314) and disable the system (or the add-on sensor 102). Further, at the step 330, the processor 240 may ignore the data from the add-on sensor 102 in relevant algorithms and apply different weights and analysis using nearby sensors data.

On the other hand, if the add-on sensor 102 is configurable or can function, then at step 332, the processor 240 may reconfigure sensor attributes. Specifically, at this step, the processor 240 may configure the FOV(s) to follow (or not to follow), ensure that the add-on sensor 102 remains in the system without sending error messages, and/or the like. After the step 332, the process 300 moves to the step 316, at which the process 300 stops.

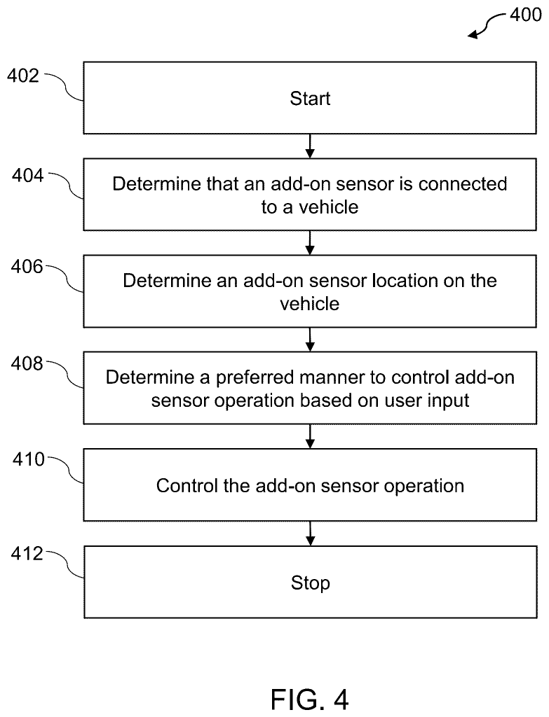

FIG. 4 depicts a flow diagram of an example second method 400 to control the add-on sensor operation in accordance with the present disclosure. FIG. 4 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 400 starts at step 402. At step 404, the method 400 may include determining, by the processor 240, that the add-on sensor 102 is connected to the vehicle 100. At step 406, the method 400 may include determining, by the processor 240, the add-on sensor location on the vehicle 100. At step 408, the method 400 may include determining, by the processor 240, the preferred manner to control the add-on sensor operation based on the user inputs. At step 410, the method 400 may include controlling, by the processor 240, the add-on sensor operation based on the preferred manner, one or more vehicle operational parameters, and/or the add-on sensor location.

At step 412, the method 400 may stop.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A vehicle comprising:
a transceiver configured to receive a user input;
a vehicle control unit configured to determine vehicle operational parameters; and
a processor configured to:
determine that an add-on sensor is connected to the vehicle;
determine a location of the add-on sensor on the vehicle;
determine a preferred manner to control an operation of the add-on sensor based on the user input; and
control the operation of the add-on sensor based on the preferred manner and at least one of the vehicle operational parameters or the location of the add-on sensor.

2. The vehicle of claim 1, wherein the preferred manner is one of an inherited control or an independent control.

3. The vehicle of claim 2, wherein the processor controls the operation of the add-on sensor based on the vehicle operational parameters and the user input when the preferred manner is the independent control.

4. The vehicle of claim 2, wherein the processor controls the operation of the add-on sensor based on the location of the add-on sensor when the preferred manner is the inherited control.

5. The vehicle of claim 4, wherein the processor is further configured to:
determine a vehicle zone at which the add-on sensor is connected based on the location;
determine one or more existing vehicle sensors located at the vehicle zone; and
control the operation of the add-on sensor based on operations of the one or more existing vehicle sensors.

6. The vehicle of claim 5, wherein the add-on sensor is communicatively coupled with the processor via a wired or wireless connection.

7. The vehicle of claim 6, wherein the processor is further configured to:
obtain inputs from the add-on sensor when the add-on sensor is activated;
obtain readings from the one or more existing vehicle sensors;
compare the inputs from the add-on sensor with the readings from the one or more existing vehicle sensors; and
output a first error notification when a difference between the inputs and the readings is greater than a predefined threshold.

8. The vehicle of claim 7, wherein the processor is further configured to:
determine whether the add-on sensor is configurable based on the inputs;
output a second error notification responsive to determining that the add-on sensor is not configurable; and
configure the add-on sensor and the one or more existing vehicle sensors to operate together responsive to determining that the add-on sensor is configurable.

9. The vehicle of claim 1, wherein the vehicle operational parameters comprise one or more of: a vehicle speed, a vehicle movement direction, a presence of a trailer attached to the vehicle, a current vehicle location, a presence of external payload on the vehicle, or operating states of one or more vehicle components.

10. The vehicle of claim 1, wherein the processor is further configured to:
determine that a user is performing a predefined action in proximity to the vehicle; and
control the operation of the add-on sensor based on the predefined action.

11. The vehicle of claim 1, wherein the processor determines the location of the add-on sensor via at least one: wireless signal triangulation from the add-on sensor to the vehicle, inputs obtained from a sensor system included in the vehicle control unit, or the user input.

12. The vehicle of claim 1, wherein the add-on sensor is one of: a camera, a Radio Detection and Ranging (radar) sensor, a Light Detection and Ranging (lidar) sensor, a microphone, an ultrasonic sensor, or a speaker.

13. The vehicle of claim 1, wherein, to control the operation of the add-on sensor, the processor turns ON the add-on sensor, transmits data obtained from the add-on sensor to a server or a vehicle infotainment system, or turns OFF the add-on sensor after a predefined time duration.

14. A method comprising:
determining, by a processor, that an add-on sensor is connected to a vehicle;
determining, by the processor, a location of the add-on sensor on the vehicle;
determining, by the processor, a preferred manner to control an operation of the add-on sensor based on a user input; and
controlling, by the processor, the operation of the add-on sensor based on the preferred manner and at least one of vehicle operational parameters or the location of the add-on sensor.

15. The method of claim 14, wherein the preferred manner is one of an inherited control or an independent control.

16. The method of claim 15, wherein controlling the operation of the add-on sensor comprises controlling the operation of the add-on sensor based on the vehicle operational parameters and the user input when the preferred manner is the independent control.

17. The method of claim 15, wherein controlling the operation of the add-on sensor comprises controlling the operation of the add-on sensor based on the location of the add-on sensor when the preferred manner is the inherited control.

18. The method of claim 17 further comprising:
determining a vehicle zone at which the add-on sensor is connected based on the location;
determining one or more existing vehicle sensors located at the vehicle zone; and
controlling the operation of the add-on sensor based on operations of the one or more existing vehicle sensors.

19. The method of claim 14, wherein the add-on sensor is one of: a camera, a Radio Detection and Ranging (radar) sensor, a Light Detection and Ranging (lidar) sensor, a microphone, an ultrasonic sensor, or a speaker.

20. A non-transitory computer-readable storage medium having instructions stored thereupon which, when executed by a processor, cause the processor to:
determine that an add-on sensor is connected to a vehicle;
determine a location of the add-on sensor on the vehicle;
determine a preferred manner to control an operation of the add-on sensor based on a user input; and
control the operation of the add-on sensor based on the preferred manner and at least one of vehicle operational parameters or the location of the add-on sensor.
